(19) United States
(12) Patent Application Publication
(10) Pub. No.: US 2007/0146302 A1
(43) Pub. Date: Jun. 28, 2007

(54) Display device and brightness self-adjusting method therefor

(75) Inventors: Chang-Jun Liu, Shenzhen (CN); Yi-Yin Chen, Miao-Li (TW); Guo-Liang Hu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/645,441

(22) Filed: Dec. 26, 2006

(30) Foreign Application Priority Data
Dec. 23, 2005 (TW) 94146369

(51) Int. Cl. G09G 3/36

(52) U.S. Cl. 345/102

(57) ABSTRACT

An exemplary display device (400) includes a display module (430), an integrated power supply (410), a display control circuit (420), a safe control circuit (465), a second power supply (460), a first sensor (425), and a second sensor (435). The integrated power supply is configured to provide electric energy to the display module. The second power supply is connected to the display control circuit via the safe control circuit, and is configured to provide electric energy to the display module via the safe control circuit. The safe control circuit is configured to adjust electric energy that is provided to the display module by the second power supply. The first sensor is connected to the display control circuit, and is configured to sense ambient brightness. The second sensor is connected to the display control circuit, and is configured to sense display brightness of the display module.

### BACKGROUND

1. Field of the Invention

The present invention relates to a display device which can self-adjust display brightness, and to a brightness self-adjusting method of the display device.

2. General Background

Display devices have been applied to various electronic equipment in which messages or pictures need to be displayed, such as computers, televisions, mobile phones, and personal digital assistants.

Referring to FIG. 3, a typical display device 100 includes an integrated power supply 110, a display control circuit 130, a display module 150, and a plurality of brightness sensors 170. The integrated power supply 110 provides power for the display control circuit 130. The display control circuit 130 sends display information to the display module 150. The brightness sensors 170 sense ambient brightness, and send signals to the display control circuit 130.

When the ambient brightness changes, the brightness sensors 170 send a brightness signal to the display control circuit 130, and the display control circuit 130 sends a control signal to the display module 150 according the brightness signal. That is, the display device 100 can self-adjust the display brightness according to the variation in ambient brightness.

However, the capacity of the display device 100 to supply electric energy for the display module 150 is liable to decline after long use of the display device 100, due to ageing of the display device 100. Therefore when the display control circuit 130 adjusts the display brightness of the display module 150, the display module 150 may not be able to precisely display the adjusted brightness. That is, the display device 100 may not precisely self-adjust the display brightness after extended use of the display device 100. Furthermore, because the integrated power supply 110 has limited electric energy, the display device 100 has a limited useful life.

Therefore, a display device and a brightness self-adjusting method thereof that can overcome the above-described problems are desired.

### SUMMARY

In one preferred embodiment, a display device includes a display module, an integrated power supply, a display control circuit, a safe control circuit, a second power supply, a first sensor, and a second sensor. The integrated power supply is configured to provide electric energy to the display module. The second power supply is connected to the display control circuit via the safe control circuit, and is configured to provide electric energy to the display module via the safe control circuit. The safe control circuit is configured to adjust electric energy that is provided to the display module by the second power supply. The first sensor is connected to the display control circuit, and is configured to sense ambient brightness. The second sensor is connected to the display control circuit, and is configured to sense display brightness of the display module.

Other advantages and novel features will become more apparent from the following detailed description when taken in conjunction with the accompanying drawings. In the drawings, all the views are schematic.

### BRIEF DESCRIPTION OF THE DRAWINGS

FIG. 1 is a block diagram of a display device according to an exemplary embodiment of the present invention.

FIG. 2 is a flow chart of a brightness self-adjusting method for the display device of FIG. 1.

FIG. 3 is a block diagram of a conventional display device.

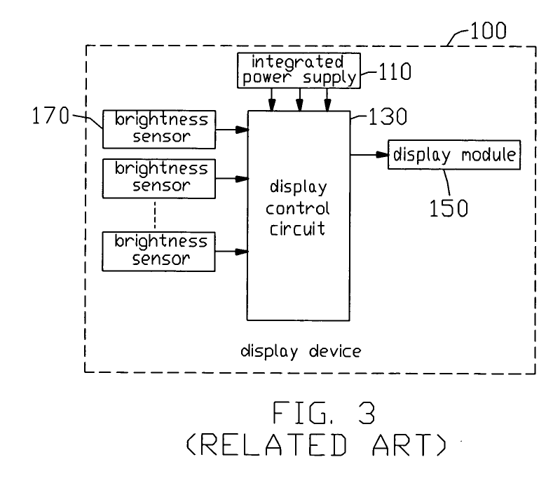

### DETAILED DESCRIPTION OF PREFERRED EMBODIMENTS

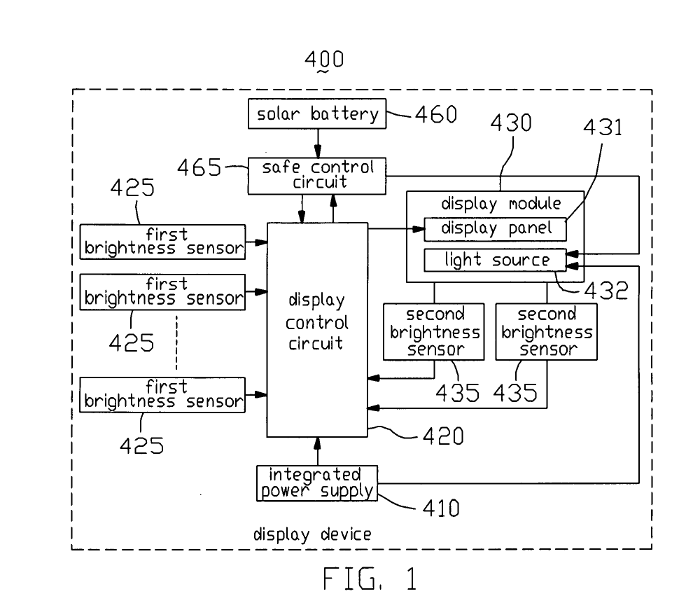

Referring to FIG. 1, a block diagram of a display device 400 according to an exemplary embodiment of the present invention is shown. The display device 400 includes an integrated power supply 410, a display control circuit 420, a plurality of first brightness sensors 425, a display module 430, a plurality of second brightness sensors 435, a solar battery 460, and a safe control circuit 465.

The integrated power supply 410 is connected to the display control circuit 420 and the display module 430 respectively, and provides power for the display control circuit 420 and the display module 430.

The solar battery 460 transforms ambient light into electric energy, and provides the electric energy to the display control circuit 420 and the light source 432 of the display module 430 via the safe control circuit 465.

The first brightness sensors 425 are connected to the display control circuit 420. The first brightness sensors 425 sense the ambient brightness, and send ambient brightness signals to the display control circuit 420.

The second brightness sensors 435 are connected to the display control circuit 420. The second brightness sensors 435 sense the display brightness of the display module 430, and send display brightness signals to the display control circuit 420.

The display control circuit 420 generates control signals according to the ambient brightness signals and the display brightness of the display module 430, and sends the controls signals to the safe control circuit 465 and the display panel 431, respectively.

In the illustrated embodiment, the display module 430 is a liquid crystal module, and includes a display panel 431 and a light source 432 for illuminating the display panel 431. The display panel 431 is connected with the display control circuit 420, and utilizes different display modes according the control signals provided by the display control circuit 420. The light source 432 is powered by the integrated power supply 410 and the solar battery 460.

The safe control circuit 465 receives control signals from the display control circuit 420, and controls the electric energy that is provided to the display control circuit 420 and the light source 432 by the solar battery 460.

In general, the display brightness of the display module 430 needs be adjusted with variation in the ambient brightness. When the ambient brightness changes, the display control circuit 420 generates control signals according to a comparative result of the ambient brightness provided by the first brightness sensors 425 and the display brightness provided the second brightness sensors 435, and sends the control signals to the safe control circuit 465 and the display panel 431, respectively. The safe control circuit 465 adjusts the electric energy that is provided to the light source 432, and the display panel 431 changes its display mode. Thus, the display device 400 self-adjusts the display brightness according to the variation in the ambient brightness.

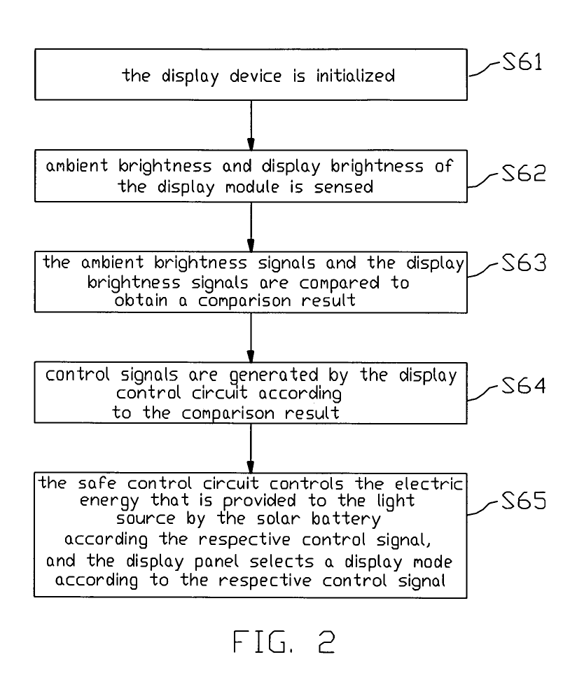

Referring to FIG. 2, this is a flow chart of the brightness self-adjusting method of the display device 400. The brightness self-adjusting method includes the following steps:

In step S61, the display device 400 is initialized.

In step S62, ambient brightness and display brightness of the display module 430 are detected. The first brightness sensors 425 sense the ambient brightness, generate ambient brightness signals, and send the ambient brightness signals to the display control circuit 420. The second brightness sensors 435 sense the display brightness of the display module 430, generate display brightness signals, and send the display brightness signals to the display control circuit 420.

In step S63, the ambient brightness signals and the display brightness signals are compared to obtain a comparative result. The display control circuit 420 receives the ambient brightness signals provided by the first brightness sensors 425 and the display brightness signals provided by the second brightness sensors 435, and compares the ambient brightness signals and the display brightness signals to obtain a comparison result.

In step S64, control signals are generated by the display control circuit 420 according to the comparison result. The display control circuit 420 generates two control signals according to the comparison result, and sends the two control signals to the safe control circuit 465 and the display panel 431, respectively.

In step S65, the safe control circuit 465 adjusts the electric energy that is provided to the light source 432 by the solar battery 460 according the respective control signal, and the display panel 431 selects a display mode according to the respective control signal.

The operation principle of the display device 400 is described as follows. When the ambient brightness increases, the first brightness sensors 425 sense this change, and send ambient brightness signals to the display control circuit 420. At the same time, the second brightness sensors 435 sense the display brightness of the display module 430, and send display brightness signals to the display control circuit 420. The display control circuit 420 compares the ambient brightness signals and the display brightness signals, and generates two control signals according to the ambient brightness signals and the display brightness signals. One of the control signals is transmitted to the display panel 431, thus the display panel 431 operates in a high brightness mode according to the control signal. The other control signal is transmitted to the safe control circuit 465, and the safe control circuit 465 increases the electric energy that is provided to the light source 432 by the solar battery 460 according to the control signal, so as to increase the illumination of the light source 432. Thus, the display brightness of the display module 430 is increased with the increasing of the ambient brightness.

When the ambient brightness decreases, the first brightness sensors 425 sense this change, and send ambient brightness signals to the display control circuit 420. At the same time, the second brightness sensors 435 sense the display brightness of the display module 430, and send display brightness signals to the display control circuit 420. The display control circuit 420 compares the ambient brightness signals and the display brightness signals, and generates two control signals according to the ambient brightness signals and the display brightness signals. One of the control signals is transmitted to the display panel 431, thus the display panel 431 operates in a low brightness mode according to the control signal. The other control signal is transmitted to the safe control circuit 465, and the safe control circuit 465 decreases the electric energy that is provide to the light source 432 by the solar battery 460 according to the control signal, so as to decrease the illumination of the light source 432. Thus, the display brightness of the display module 430 is decreased with the decreasing of the ambient brightness.

In summary, the display device 400 includes the first brightness sensors 425 for sensing the ambient brightness, the second brightness sensors 435 for sensing the display brightness of the display module 430, and the solar battery 460 used as a second power supply of the light source 432. When the ambient brightness changes, the display brightness of the display module 430 can be adjusted by adjusting the electric energy that is provided to the light source 432 by the solar battery 460 according to the result of comparison of the ambient brightness and the display brightness. That is, the display device 400 can precisely self-adjust its display brightness. Furthermore, the integrated power supply 410 is not used for the self-adjusting operation. Therefore, the display device 400 has an increased useful life.

Further or alternative embodiments may include the following. In one example, the display device includes a single first brightness sensor and a single second brightness sensor. In another example, the display device is a cathode ray tube display device, and self-adjusts display brightness by controlling energy of an electron gun of the cathode ray tube display device. In a further example, the display device is a plasma display device, and self-adjusts display brightness by controlling a voltage which initiates plasma reaction.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A display device comprising:
a display module;
an integrated power supply configured to provide electric energy to the display module;
a display control circuit;
a safe control circuit;
a second power supply connected to the display control circuit via the safe control circuit and configured to provide electric energy to the display module via the safe control circuit;
a first sensor connected to the display control circuit and configured to sense ambient brightness; and
a second sensor connected to the display control circuit and configured to sense display brightness of the display module;
wherein the safe control circuit is configured to adjust electric energy that is provided to the display module by the second power supply.

2. The display device as claimed in claim 1, wherein the second power supply comprises a solar battery.

3. The display device as claimed in claim 2, wherein the display control circuit is configured to receive an ambient brightness signal from the first sensor and a display brightness signal from the second sensor, generate a first control signal according to the brightness signals, and provide the first control signal to the safe control circuit.

4. The display device as claimed in claim 3, wherein the display module comprises a display panel, and the display control circuit is further configured to generate a second control signal according to the brightness signals and send the second control signal to the display panel.

5. The display device as claimed in claim 4, wherein the display module further comprises a light source configured for illuminating the display panel, and the light source is connected with the integrated power supply and the second power supply.

6. The display device as claimed in claim 1, wherein the display module is a liquid crystal module.

7. A brightness self-adjusting method for the display device of claim 1, comprising:
the first sensor sensing ambient brightness and generating an ambient brightness signal;
the second sensor sensing display brightness of the display module and generating a display brightness signal;
the display control circuit comparing the ambient brightness signal provided by the first sensor and the display brightness signal provided by the second sensor, generating a control signal according to a result of comparing the ambient brightness signal and the display brightness signal, and sending the first control signal to the safe control circuit; and
the safe control circuit adjusting electric energy that is provided to the display module by the second power supply according to the first control signal.

8. The brightness self-adjusting method as claimed in claim 7, wherein the display module comprises a display panel, and the brightness self-adjusting method further comprises the display control circuit generating a second control signal and sending the second control signal to the display panel.

9. The brightness self-adjusting method as claimed in claim 8, wherein the display panel selects a brightness mode according to the second control signal.

10. The brightness self-adjusting method as claimed in claim 8, wherein the display device further comprises a light source configured for illuminating the display panel and connected with the integrated power supply and the second power supply, and the brightness self-adjusting method further comprises the safe control circuit adjusting the electric energy that is provided to the light source by the second power supply according to the first control signal.

11. The brightness self-adjusting method as claimed in claim 7, wherein the display module is a liquid crystal module.

12. The brightness self-adjusting method as claimed in claim 9, wherein when the ambient brightness increases, the display panel operates in a higher brightness mode and the safe control circuit increases the electric energy that is provide to the light source by the second power supply.

13. The brightness self-adjusting method as claimed in claim 9, wherein when the ambient brightness decreases, the display panel operates in a lower brightness mode and the safe control circuit decreases the electric energy that is provide to the light source by the second power supply.

14. The brightness self-adjusting method as claimed in claim 7, wherein the second power supply comprises a solar battery.

15. A display device comprising:
a display module;
a display control circuit;
a first sensor configured to sense ambient brightness; and
a second sensor configured to sense display brightness of the display module;
wherein the display control circuit adjusts the display brightness of the display module according a result of comparing an ambient brightness measurement provided by the first sensor and a display brightness measurement provided by the second sensor.
